(19) United States
(12) Patent Application Publication
(10) Pub. No.: US 2007/0079766 A1
(43) Pub. Date: Apr. 12, 2007

(54) Beauty, medical treatment, and bath system for pet animal

(76) Inventor: Sang-Hee Park, Gyeonggi-Do (KR)

Correspondence Address: IPLA P.A., 3580 WILSHIRE BLVD., 17TH FLOOR, LOS ANGELES, CA, 90010, US

(21) Appl. No.: 10/596,073

(22) PCT Filed: Jul. 15, 2004
(86) PCT No.: PCT/KR04/01757

§ 371 Date: May 26, 2006

(30) Foreign Application Priority Data
Dec. 3, 2003 (KR) 10-2003-0087025
Jul. 13, 2004 (KR) 10-2004-0054410

(51) Int. Cl. A01K 13/00

(52) U.S. Cl. 119/674

(57) ABSTRACT

A system having beauty, medical and bath functions for pets capable of easily achieving beauty, medical and bath functions for pets at home, pets hospital and pets shop is disclosed. The system having beauty, medical and bath functions for pets, comprising a bathtub stand for fixing a pet's head and body; a bathtub stand height adjusting unit for supporting the bathtub and adjusting the height of the bathtub stand; and a bathtub for storing water therein, wherein said bathtub stand height adjusting unit is installed at a bottom of the bathtub.

### TECHNICAL FIELD

The present invention relates to a system having beauty, medical and bath functions for pets capable of easily achieving beauty, medical and bath functions for pets at home, pets hospital and pets shop, and in particular to a bath system for pets that is designed to minimize a pets stress and easily achieve a bath, beauty (dry, dyeing, ear cleaning, etc.) or a medical operation (vaccination, medical check, operation, medicinal bath, etc.).

### BACKGROUND ART

Many homes feed many kinds of pets such as dog, cat, and the like. The pets are known to give people pleasure. However, in the case that bath, beauty and medical operations are not provided to pets timely, the pets may become mediums such as flea, tick, bacteria, etc., for thereby causing various diseases such as skin diseases, etc. to pets and infecting to humans. Hairs of pets may become one factor of causing allergies and polluting surrounding environments.

In particular, in the case that the pets become mediums of diseases or bacteria in our residential environments, for example, apartment environment, the mediums may affect other homes. Therefore, the people who feed the pets should be careful of their hygienic states periodically.

The conventional pet bathing operations will be described. First, a certain pet is inputted into a bath full with water, and the pet is bathed with one hand using water or shower tap, holding the pet with the other hand so that water is not inputted into the pet's eyes and nose. After the bath is finished, the hairs of the pet are dried using a hair drier.

The owner of the pet dries the hairs of the pet after the pet took bath. At this time, the hairs may fall out and fly during the driving operation of the wet hairs or may be gathered on the floor for thereby causing unsanitary problems.

A pet bath apparatus that has been imported from other countries and has been used in some pets hospitals is too expensive, so that a common pet owner cannot buy and use it due to high cost. Therefore, many pet owners perform a bathing operation in the above-described method.

In particular, even though the pet is not bathed with hot water in the wiriter season among four seasons, if the pet's wet hairs are not dried fast, the pet may have a cold. When the pet has a cold, it is very hard to cure the cold. In some cases, the cold may be changed to pneumonia.

In the conventional pets bathtub, hot water is filled in the bathtub before taking a bath, and the pet is inputted into the bathtub for thereby performing a pet's bath. However, time is passed, the water in the bathtub get cooled, so that the pet cannot be adapted to the cooled water, whereby the pet may have a cold or pneumonia. In the conventional pet bathtub, the pet is bathed in a method that the pet has a shower using a shower tab provided separately from the bathtub. In this case, the shower can be provided to the pet only when hot water is supplied. Therefore, lot of water and power are consumed for thereby causing over consumption.

### DISCLOSURE OF INVENTION

Accordingly, it is an object of the present invention to overcome the problems encountered in the conventional art.

It is another object of the present invention to provide a bath system having beauty, medical and bath functions for pets capable of providing pets with bath, medicinal bath and dry at any places and whole body beauty, ear cleaning, dyeing, vaccination and therapy in such a manner that a pet bathtub system includes a bathtub stand, a bathtub stand height adjusting unit and a bathtub.

It is further another object of the present invention to provide a bath system having beauty, medical and bath functions for pets capable of minimizing occurrences of diseases due to a fast change of pet body temperature during a bathing by installing heat wires at the bottom of a bathtub.

It is still further another object of the present invention to provide a bath system having beauty, medical and bath functions for pets capable of achieving an easier drying and shower of pets without using additional drier or shower tab in such a manner that a drier arm or shower unit arm is rotatably installed at one side of an inner upper end of a bathtub.

In the system having beauty, medical and bath functions for pets according to the present invention, bathing, beauty (dry, dyeing, ear cleaning, massage, etc.) or medical operations (vaccination, medical check, operation, etc.) can be performed at any places. The present invention has the following advantages.

First, the present invention is directed to one stop system. The user can easily use the system for bathing, dry, beauty, medicinal bath, dyeing, ear cleaning, etc. for pets at one place.

Second, the user can effectively perform beauty, medical operation and bathing for a short time period with a comfortable posture irrespective of the size and weight of the pet.

Third, the user can provide the pets with bathing at various angles and conveniently and freely using a function of freely adjusting the height of a bathtub stand, a 360° rotation plate, a shower tab support, a rotatable shower unit arm or drier arm.

Fourth, in the present invention, it is possible to provide the pets with beauty, medical operation and bathing in a state that the pet is placed on a bathtub stand in comfortable posture for thereby minimizing a certain stress caused when the pet has beauty, medical operation and bathing.

Fifth, since whole parts of pet can be fully dried using a rotation function in such a manner that the body of pet is fully lifted up for thereby preventing any diseases such as skin diseases.

Sixth, the angle, width and length of the bathtub stand can be adjusted based on the difference sizes of the pets, so that the present invention can be well adapted to various kinds of pets.

Seventh, water is prevented from being inputted into the pet's eyes, nose, and mouth during shower using a protection cap, so that whole parts of a pet's body can be washed using both hands.

Eighth, it is possible to save more water and shampoo as compared to the conventional bathing method. In particular, the present invention is designed to recycle water of the bathtub, so that the water and power can be significantly saved.

Ninth, the present invention adapts a method for continuously heating water by installing heat wires on the bottom of a bathtub, so that it is possible to prevent pet's diseases such as cold or pneumonia that may occur due to the down of temperature. In particular, the power supplied to the heat wires can be properly controlled, so that it is possible to maintain the temperature of bathtub water at a certain set temperature.

Tenth, whole parts of a pet's body can be effectively dried or can have shower using a drier or shower tab in such a manner that a drier arm or shower unit arm is rotatably installed at one side of an inner upper end of a bathtub. In addition, the drier arm or shower unit arm is installed in a certain direction of a body portion of a pet, so that the user can dry the pet or give a shower to the pet using user's both hands.

Eleventh, the pet can be bathed without shampoo in such a manner that an ultrasonic wave generator, far infrared ray generator and electrolysis apparatus are installed at the bottom of a bathtub. In addition, tick, bacteria, etc. who live in the body of the pet can be eradicated.

To achieve the above objects, according to an embodiment of the present invention, there is provided a system having beauty, medical and bath functions for pets, comprising a bathtub stand for fixing a pet's head and body; a bathtub stand height adjusting unit for supporting the bathtub and adjusting the height of the bathtub stand; and a bathtub for storing water therein, wherein said bathtub stand height adjusting unit is installed at a bottom of the bathtub.

In the present invention, the bathtub stand includes a head rest and fixing band for fixing a pet's head; a neck fixing member for adjusting the length and angle based on a pet's neck size; and a body length adjusting member for adjusting the length based on the size of the pet.

To achieve the above objects, according to another embodiment of the present invention, there is provided a system having beauty, medical and bath functions for pets, comprising a bathtub stand for fixing a pet's head and body; a bathtub stand height adjusting unit for supporting the bathtub and adjusting the height of the bathtub stand; and a stand leg unit that operates as a support for supporting the bathtub stand height adjusting member and includes a suspension bar connected between the both ends of the legs.

### BRIEF DESCRIPTION OF DRAWINGS

The present invention will become better understood with reference to the accompanying drawings which are given only by way of illustration and thus are not limitative of the present invention, wherein;

FIGS. 1 through 3 are cross sectional views illustrating a system having beauty, medical and bath functions for pets according to an embodiment of the present invention;

FIG. 4 is a plan view illustrating a system having beauty, medical and bath functions for pets according to an embodiment of the present invention;

FIG. 5 is a perspective view illustrating a frame of a bathtub stand adapted to a system having beauty, medical and bath functions for pets according to an embodiment of the present invention;

FIG. 6 is a view illustrating a detailed construction and use state of a protection cap hinged to a head-fixed band of a bathtub stand of FIG. 5;

FIG. 7 is a view illustrating the connection portions A, B, C and D indicated on a bathtub stand of FIG. 5;

FIG. 8 is a view illustrating a head-fixed height adjusting button indicated on a bathtub stand of FIG. 5;

FIG. 9 is a view illustrating a state that a pet is dried in a system having beauty, medical and bath functions for pets according to an embodiment of the present invention;

FIG. 10 is a view illustrating a state that a pet is bathed in a system having beauty, medical and bath functions for pets according to an embodiment of the present invention;

FIGS. 11 and 12 are views illustrating a pedal type structure for adjusting a bathtub stand height adjusting unit adapted to a system having beauty, medical and bath functions for pets according to an embodiment of the present invention;

FIG. 13 is a cross sectional view illustrating a heat wire installed at the bottom of a bathtub in a system having beauty, medical and bath functions for pets according to an embodiment of the present invention;

FIG. 14 is a projection plan view illustrating a heat wire installed in a system having beauty, medical and bath functions for pets of FIG. 13;

FIG. 15 is a perspective view illustrating a drier arm and shower unit arm in a system having beauty, medical and bath functions for pets according to an embodiment of the present invention;

FIG. 16 is a detailed view illustrating the whole construction of a drier arm and shower unit arm of a system having beauty, medical and bath functions for pets according to an embodiment of the present invention;

FIG. 17 is a perspective view illustrating a structure that a drier arm and shower unit arm are engaged in a system having beauty, medical and bath functions for pets according to an embodiment of the present invention;

FIG. 18 is an operation state view illustrating a state that a drier arm and shower unit arm are operated in a system having beauty, medical and bath functions for pets according to an embodiment of the present invention;

FIG. 19 is a perspective view illustrating a state that a drier arm and shower unit arm are engaged at a side portion of a bathtub in a system having beauty, medical and bath functions for pets according to an embodiment of the present invention;

FIGS. 20 and 21 are perspective views illustrating the unfolded and folded states of a system having beauty, medical and bath functions for pets according to another embodiment of the present invention;

FIG. 22 is a perspective view illustrating a stand leg part of a system having beauty, medical and bath functions for pets according to the present invention;

FIG. 23 is a view of an operation state of a method for folding a stand is leg part of FIG. 22; and

FIG. 24 is a view of a use state of a system having beauty, medical and bath functions for pets according to an embodiment of the present invention.

### BEST MODE FOR CARRYING OUT THE INVENTION

In the descriptions, the pets represent dog, cat, pig, etc. that can be fed at home.

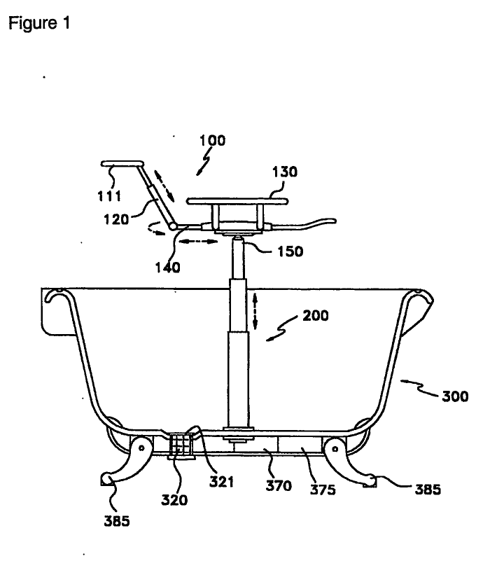

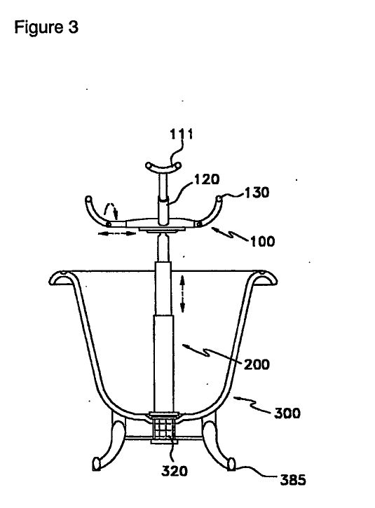

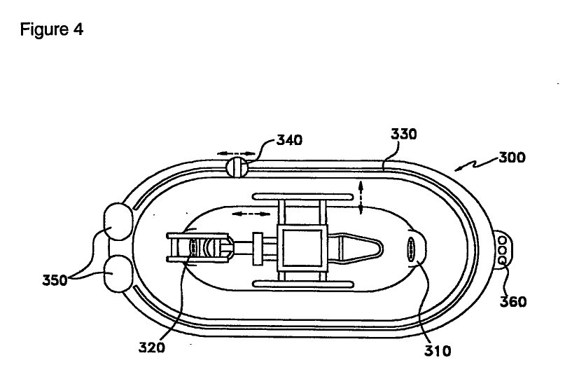

FIGS. 1 through 3 are cross sectional views illustrating a system having beauty, medical and bath functions for pets according to an embodiment of the present invention, and FIG. 4 is a plan view illustrating a system having beauty, medical and bath functions for pets according to an embodiment of the present invention. As shown therein, the system having beauty, medical and bath functions for pets according to the present invention includes a bathtub stand 100 for fixing a pet's head and body during a beauty, medical operation or bathing, a bathtub stand height adjusting unit 200 for supporting the bathtub stand 100 and adjusting the height of the bathtub stand 100, and a bathtub 300 filled with water therein. In addition, the bathtub stand height adjusting unit 200 is attached at the bottom of the bathtub.

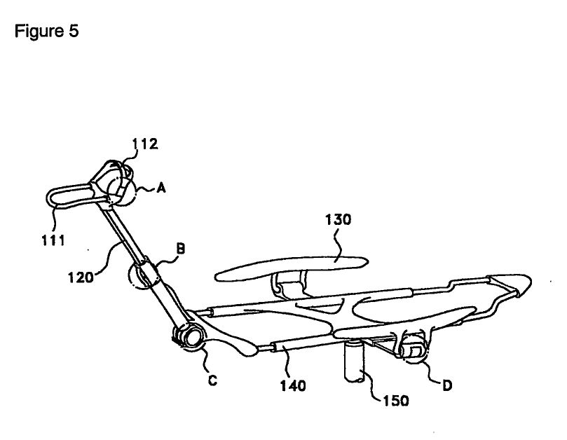

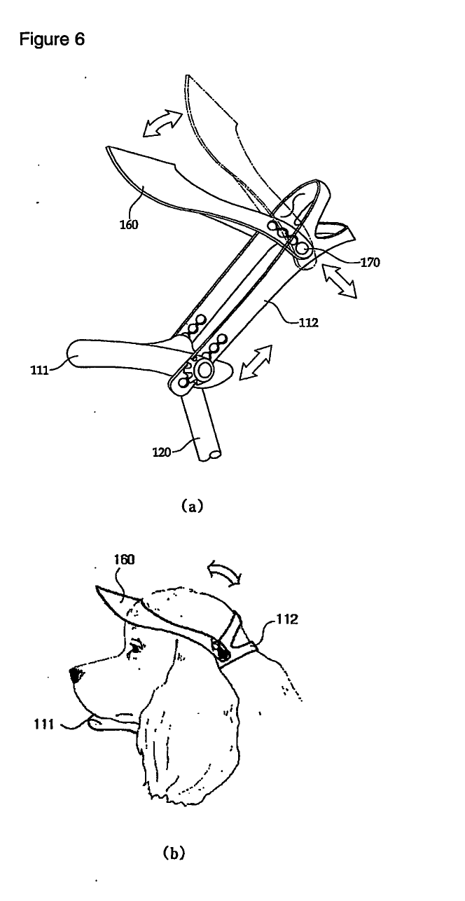

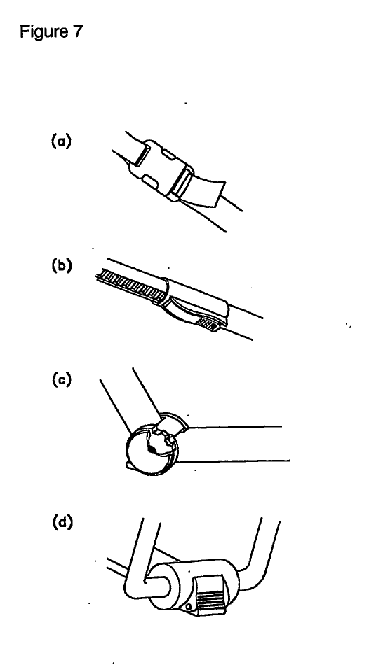

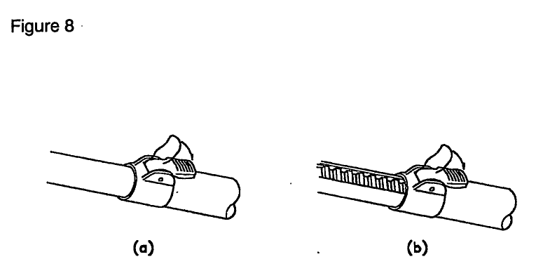

FIG. 5 is a perspective view illustrating a frame of a bathtub stand adapted to a system having beauty, medical and bath functions for pets according to an embodiment of the present invention, FIG. 6 is a view illustrating a detailed construction and use state of a protection cap hinged to a head-fixed band of a bathtub stand of FIG. 5, FIG. 7 is a view illustrating the connection portions A, B, C and D indicated on a bathtub stand of FIG. 5, and FIG. 8 is a view illustrating a head-fixed height adjusting button indicated on a bathtub stand of FIG. 5.

As shown in FIG. 5, the bathtub stand 100 includes a head support rest 111 and a fixing band 112 (A), a neck fixing member 120 (B, C), a body side safety support fixing member 130 (D), a body length adjusting member 140 and a bathtub stand rotation member 150.

At this time, the bathtub stand 100 is made of a soft plastic resin (for example, ABS resin, ion exchange resin, and the like), and the head support rest 111 and the body side safety support fixing member 130 are made of an aluminum or hard plastic resin because they need a stronger support.

In detail, the pet's head support rest 111 and the fixing bans 112 (A) have functions of fixing the pet's head during the beauty, medical operation or bathing. At this time, as shown in FIG. 7A, the fixing band 112 is formed of a clip so that the band size is adjusted based on the size of the pet's head. Namely, in the case that the pet has a big size head, the clip is simply adjusted for thereby extending the length of the band.

The neck fixing member 120 (B, C) has a function of adjusting the length and angle based on the neck size of the pet. As shown in FIGS. 7B and 7C, there are provided a height adjusting button 121 and an angle adjusting button 122.

Here, the height adjusting button 121 may be formed in a button-based tooth wheel handle type (FIG. 7B) or a tightening handle type (FIG. 8A) or a tightening tooth wheel handle type (FIG. 8B) for thereby easily adjusting the height.

The angle adjusting button 122 may be formed in a three-step adjusting method and may be formed in a button type for an easier adjustment.

The angle and width of the body side safety support fixing member 130 can be adjusted based on the size of the pet's body. The body side safety fixing member 130 has a function of laterally and stably supporting the left and right sides of the body of the pet during the beauty, medical operation or bathing.

At this time, as shown in FIG. 7D, an angle adjusting joint button provided at the body side safety support fixing member 130 is fabricated in a joint type so that the angle can be adjusted at one time using buttons.

The length of the body length adjusting member 140 can be adjusted based on the pet's size. In particular, the distance between the front legs and the rear legs can be adjusted with respect to the pet's abdomen.

The bathtub stand 100 can be rotatable by the bathtub stand rotation member 150 at 360° with the four adjusting steps (left, right, upper and lower directions). Therefore, the bathtub stand can be rotated in the left, right, upper and lower directions during the bathing, beauty and medical operation for thereby achieving convenient operations.

The bathtub height adjusting member 200 has a function of freely lifting up and lowering the bathtub irrespective of the size and weight of the pet with a three-step adjusting method.

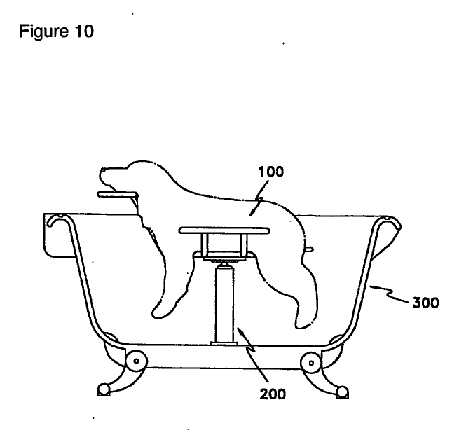

As shown in FIG. 10, the pet's feet do not reach the bottom of the bathtub even before the height adjusting function is used. In the case that the bathtub is filled with water, the water is filled at a pet's back height so that the whole body of the pet is flooded for thereby achieving easier bathing (medicinal bathing and massage).

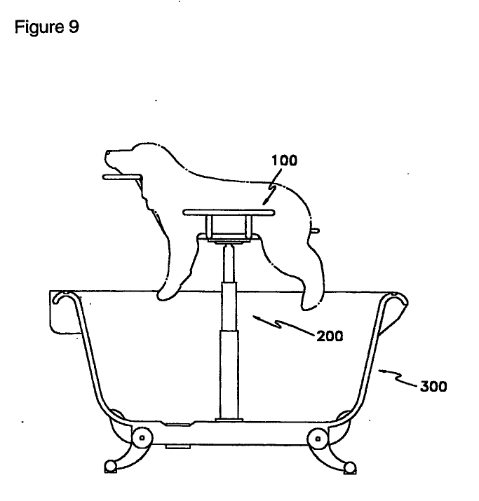

As shown in FIG. 9, even when the pet is lifted up to the highest height using the height adjusting function, the pet's legs do not reach the upper plate of the bathtub for thereby achieving easier rotation.

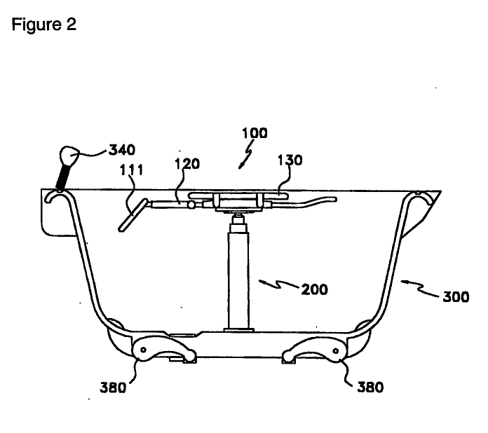

As shown in FIG. 2, in the system having beauty, medical operation and bathing for pets, the upper plate of the bathtub stand can be folded into the bathtub and can be stored after the use of the same is finished.

As shown in FIG. 6A, the protection cap 160 is hinged to the head fixing band 112, so that it is possible to prevent water from being inputted into pet's eyes, nose and mouth during the bathing. In particular, as indicated by the arrows in FIGS. 6A and 6B, the protection cap 160 is rotated with respect to a hinge shaft 170, so that the protection cap 160 can be easily covered or uncovered. In addition, the length of the protection cap 160 can be adjusted based on a simple operation of the clip.

As shown in FIGS. 1 through 4, the construction of the bathtub 300 will be described. A bubble generator 310 is installed at one side surface of the bottom of the bathtub. A drainage 320 having a filtering net 321 is installed at the opposite surface. The bottom of the bathtub is embossed.

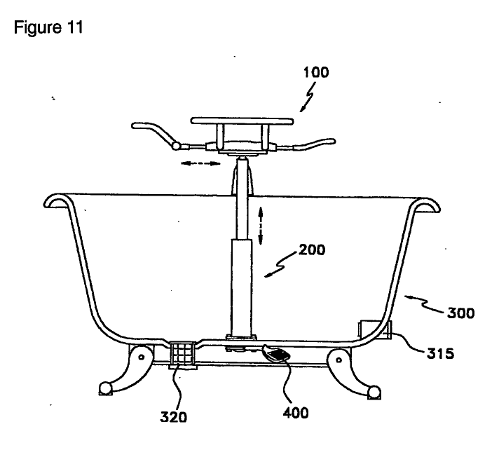

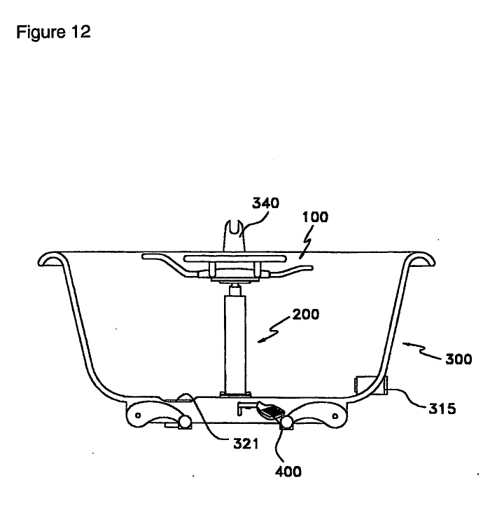

The bubble generator 310 has three-step level adjusting functions (high, middle, low) using two bubble generators installed in the interior of the bathtub. The three-step level adjusting functions are adjusted by a timer of a button type spa controller 360. Here, in FIGS. 11 and 12, reference numeral 315 represents a bubble generator socket.

A three-step filtering net 321 is installed at the drainage 320 for fully filtering small hairs of pet.

The bottom of the bathtub is embossed using rubber for preventing sliding of pet.

An elliptical rail 330 and a shower unit support member 340 are installed at the upper plate of the bathtub 300, and a shampoo and rinse support 350 and a button type spa controller 360 are installed at one side and other side of the same.

At this time, a pack storing space is formed at a lower side of the shampoo and rinse support 350 for storing a pack insertion net therein.

An elliptical rail 330 is installed at the upper plate of the bathtub. A shower unit support 340 is supported by the guide part of the elliptical rail 330. Therefore, the shower unit support 340 can be freely movable along the elliptical rain 330. The angle and rotation of the shower can be adjusted. A shampoo, rinse and towel hanger is installed at the upper plate support for convenient use.

The button type spa controller 360 is formed of a button type control panel and is designed to simply adjust the spa function with high, middle and low levels.

A bubble motor 370 and a charge battery 375 are installed at a lower side of the bathtub 300. Bathtub legs 385 each having a non-slip type wheel 380 are provided at one side and the other side for thereby achieving an easier movement of the bathtub 300.

As shown in FIG. 2, the bathtub legs 385 are foldable, so that they are folded and stored in the bathtub. The wheels 380 are provided at the folded leg portions, so that it is easy to move the same. In addition, the bathtub legs 385 have a horizontal adjusting function. When the bathtub is placed on the floor, the horizontal movement and sliding are prevented.

Therefore, in the present invention, it is possible to implement a spa system capable of performing medicinal bathing, massage and bubble bathing based on the above described construction.

Namely, the medicinal bathing function of the spa system is achieved in such a manner that a proper amount of water is filled in the bathtub, and medical shampoo or medical pack is inputted into the bathtub. Therefore, the medical components affect deep skins, so that it is possible to prevent and cure various ticks and skin diseases.

The massage function is directed to loosening pet's muscles using bubbles generated during the bathing for thereby achieving a desired massage effect together with diet effect.

The bubble bathing function is directed to removing a certain smell of pet by inputting a certain medical herb or aroma into the water of the bathtub. The effects of the same may last for a long time.

FIG. 9 is a view of a state that pet's wet hairs are dried in a system having beauty, medical and bath functions according to an embodiment of the present invention.

As shown therein, when the pet's hairs are dried after bathing, since the angle and height of the bathtub stand 100 can be freely adjusted, it can be effectively used for different sizes of pets. In particular, when the pet's hairs are dried after bathing, the bathtub stand is lifted up at a certain height, so that the drying operation can be effectively performed, rotating the same 360°.

FIG. 10 is a view of a state that a pet is bathed using a system having beauty, medical and bath functions for pets according to an embodiment of the present invention.

As shown in FIG. 10, the bathtub stand 100 is designed to have various bathing effects such as massage, bubble, bathing, medicinal bathing and steam massage effects using a spa system function.

FIGS. 11 and 12 are views illustrating a pedal type structure capable of adjusting the height of a bathtub stand in a system having beauty, medical and bath functions for pets according to an embodiment of the present invention.

The bathtub stand height adjusting unit 200 according to the present invention may be designed to operate based on a full automatic method or a semi-automatic method. Namely, as shown in FIGS. 11 and 12, the semi-automatic method is designed to use a semi-automatic pneumatic or hydraulic cylinder function using a height adjusting pedal 400.

In. addition, the automatic method is designed to use a motor driving force. Some operation buttons may be provided for easier operation. In the present invention, both the automatic and semi-automatic methods may be adapted.

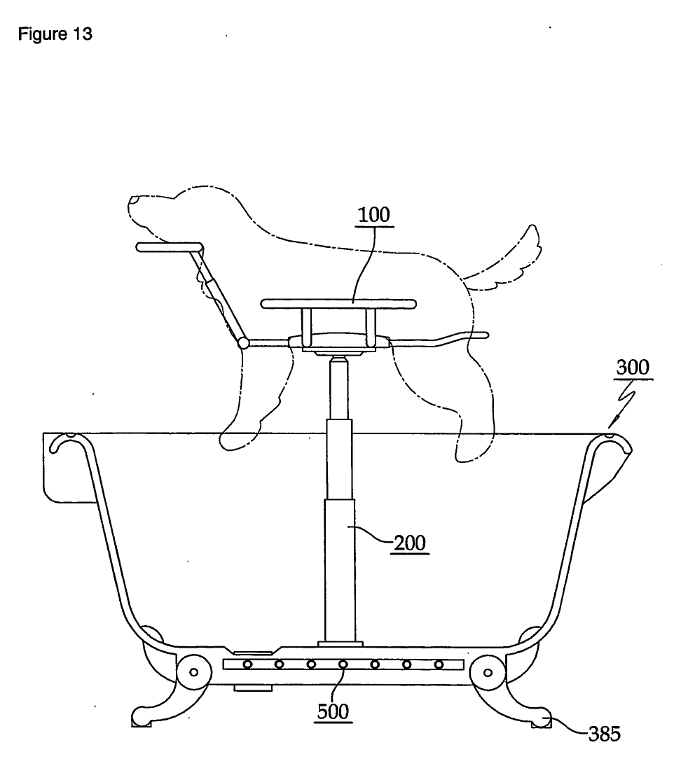

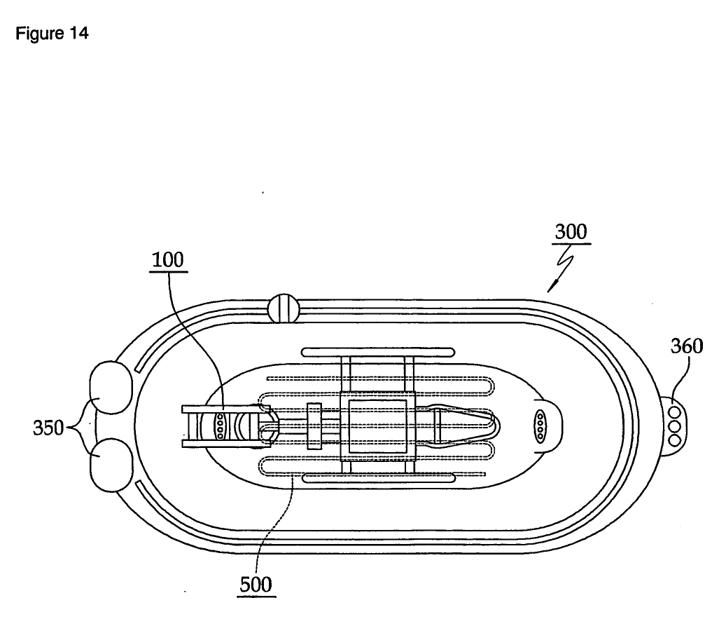

FIG. 13 is a cross sectional view illustrating a heat wire installed at the bottom of the bathtub in a system having beauty, medical and bath functions for pets according to an embodiment of the present invention. FIG. 14 is a projection plan view illustrating a heat wire installed in a system having beauty, medical and bath functions for pets of FIG. 13.

As shown in FIGS. 13 and 14, a heat wire 500 is installed at the bottom of the bathtub. Power is supplied to the heat wire 500 based on an on and off operation of a heat wire control button (not shown) for thereby heating the water in the bathtub up to a certain temperature or continuously maintaining the water temperature at a set level. An automatic temperature adjusting device can be further installed at the bathtub for measuring the temperature of water in the bathtub and maintaining the water temperature of the bathtub at a set level. In particular, with the above device, it is possible to easily maintain the water temperature of the bathtub at a set level by controlling the power supplied to the heat wire.

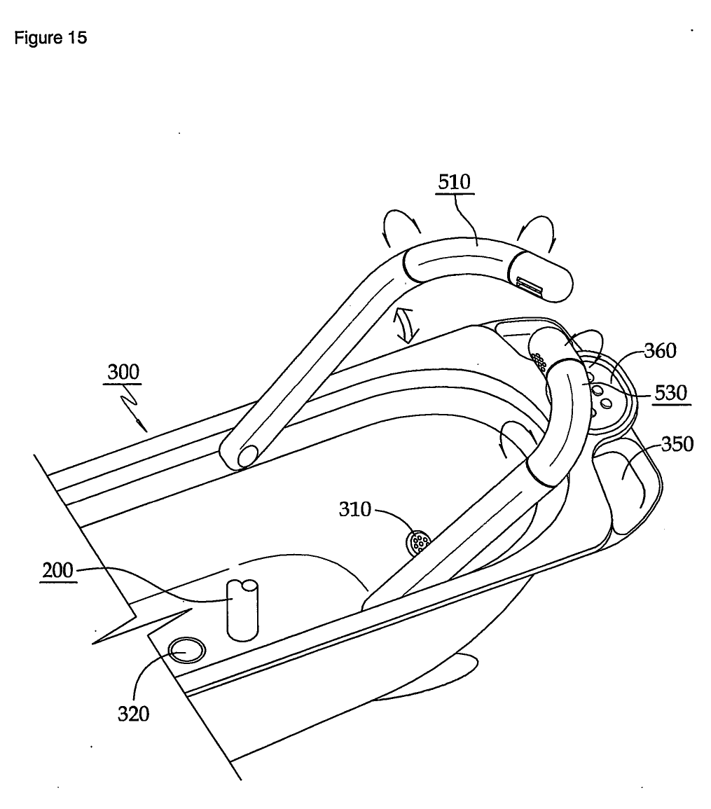

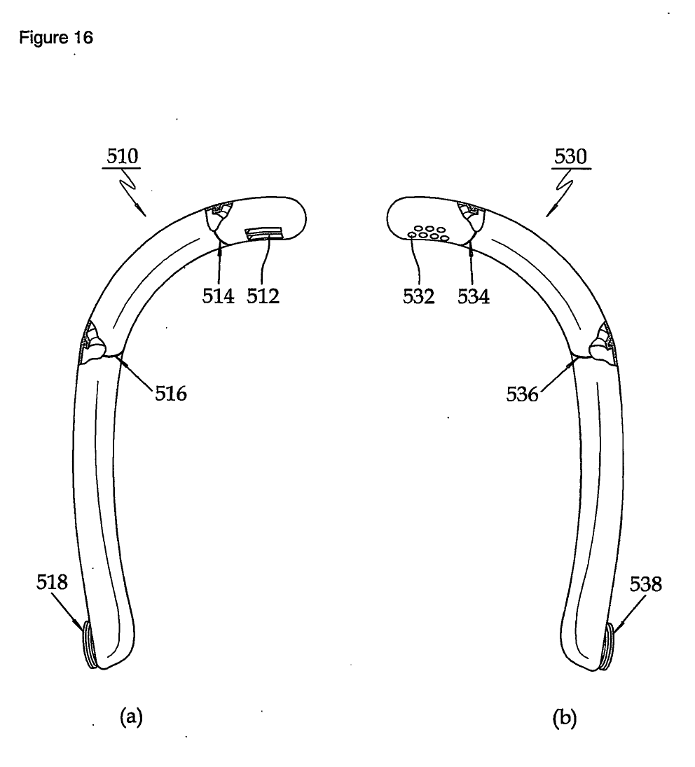

FIG. 15 is a perspective view illustrating a drier arm and shower unit arm in a system having beauty, medical and bath functions for pets according to an embodiment of the present invention, and FIG. 16 is a detailed view illustrating the whole construction of a drier arm and shower unit arm of a system having beauty, medical and bath functions for pets according to an embodiment of the present invention.

As shown in FIG. 15, the drier arm 510 or the shower unit arm 530 is free-rotatably hinged to one side surface of the inner upper end of the bathtub. As shown in FIG. 16A, the drier arm 510 has a plurality of rotation joints 514, 516 and 518 for free movements. Since the drier arm 510 is designed to freely rotate, the user of the bathtub can effectively dry all parts of a pet body, rotating the drier arm 510. In particular, in the shower unit support 340, the user can adjust a discharge port 512 of the drier arm 510 toward a certain portion that needs heated air, so that all hairs can be effectively dried using both hands. The elliptical rail 330 may be installed at the guide of the upper plate of the bathtub based on the shape of the bathtub, so that the angle of the shower unit can be freely adjusted, and the shower support can be freely rotated. In addition, a shampoo, rinse and towel hanger is installed on the support of the upper plate for convenient use. As shown in FIG. 16B, the shower unit arm 530 includes a plurality of rotation joints 534, 536 and 538 for free movement like the drier arm 510. Since the shower unit arm 530 is freely rotatable, the user of the bathtub can bathe all parts of the pet using the rotatable shower unit arm 530. In particular, the user positions the shower nozzle 532 of the shower unit arm 530 toward a desired portion and bathes the pets using two hands. A shower unit support (not shown) for detachably engaging the shower unit may be provided at the ends of the shower unit arm 530.

In this case, water sprayed through the shower nozzle 532 is supplied from the bathtub using a motor of the spa system provided in the bathtub or is supplied from the bathtub by an additionally provided motor. Namely, in the present invention, it is possible to recycle the water in such a manner that the water is pumped from the bathtub and is sprayed through the shower nozzle without a water supply from the outside. Therefore, it is possible to save a lot of water as compared to the method of bathing using an additionally provided shower unit. In addition, a ultrasonic wave generator or far infrared ray generally may be further provided at a lower side of the bathtub for generating ultrasonic wave or far infrared ray for thereby killing bacteria and harmful insects. In addition, an electrolysis device may be installed at a lower side of the bathtub for thereby washing the pet's body and killing tick, bacteria, etc. who live in the pet. In particular, the ultrasonic wave generator, far infrared ray generator and electrolysis device may be applied in combination for thereby more effectively bathing the pets without pet shampoo. It is possible to prevent a certain disease like skin disease by killing tick, bacteria, etc. living in the body of the pet. Various kinds of filters may be installed at a lower side of the bathtub for thereby continuously filtering the water. Here, the filter may be selected from the group comprising a carbon filter, micro filter, reverse-osmotic pressure filter, ion exchange resin filter, ceramic filter, etc. that have been generally used in a water purifier. In the case that the water of the bathtub is pumped from the bottom of the bathtub using a motor, the pets hairs or foreign substances are effectively filtered by the filter for thereby purifying the water. Therefore, it is possible to always keep the water cleaned wherein the water is sprayed through the shower nozzle.

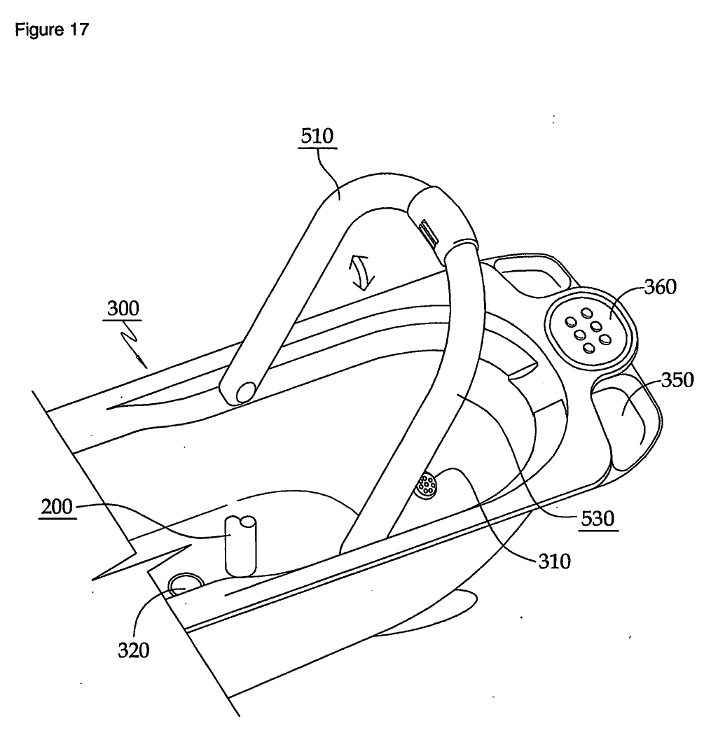

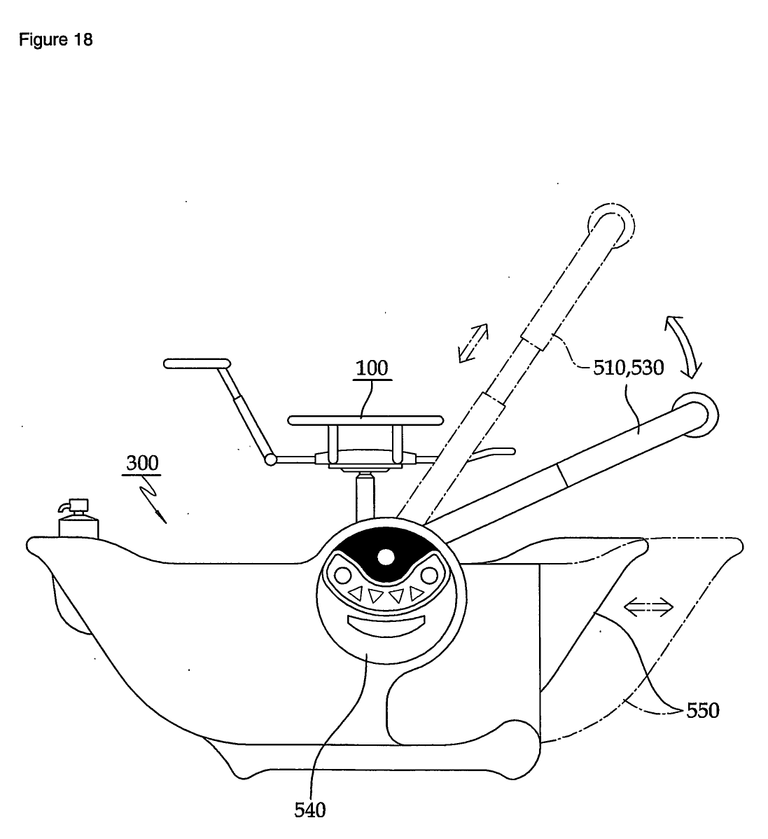

FIG. 17 is a perspective view illustrating a structure that a drier arm and shower unit arm are engaged in a system having beauty, medical and bath functions for pets according to an embodiment of the present invention, and FIG. 18 is an operation state view illustrating a state that a drier arm and shower unit arm are operated in a system having beauty, medical and bath functions for pets according to an embodiment of the present invention.

As shown in FIG. 17, the drier arm 510 and the shower unit arm 530 may be combined together. As shown in FIG. 18, the combined drier arm 510 and shower unit arm 530 may be extended in the longitudinal direction and may be rotatable in the forward and backward directions with respect to the rotary shaft. The extension and rotation functions may be controlled using the bathtub control unit 540. In particular, the length of the bathtub may be freely adjusted using a certain driving unit (not shown). It may be adapted irrespective of the size of the pet.

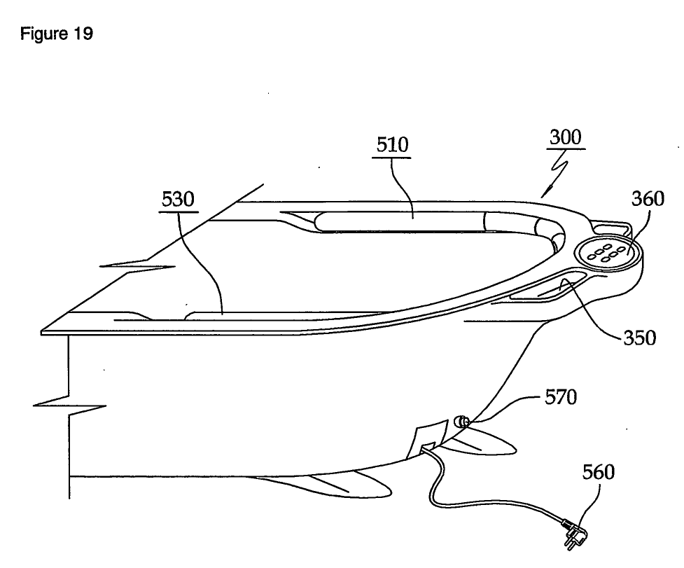

FIG. 19 is a perspective view illustrating a state that a drier arm and shower unit arm are engaged at a side portion of a bathtub in a system having beauty, medical and bath functions for pets according to an embodiment of the present invention. As shown therein, the drier arm 510 and the shower unit arm 530 are provided on the side surface of the upper end of the bathtub for thereby achieving an easier storing and minimizing the total volume. A power plug winding button 570 is installed at a portion of a power input unit. When the button is pushed, the power plug 560 is automatically wound.

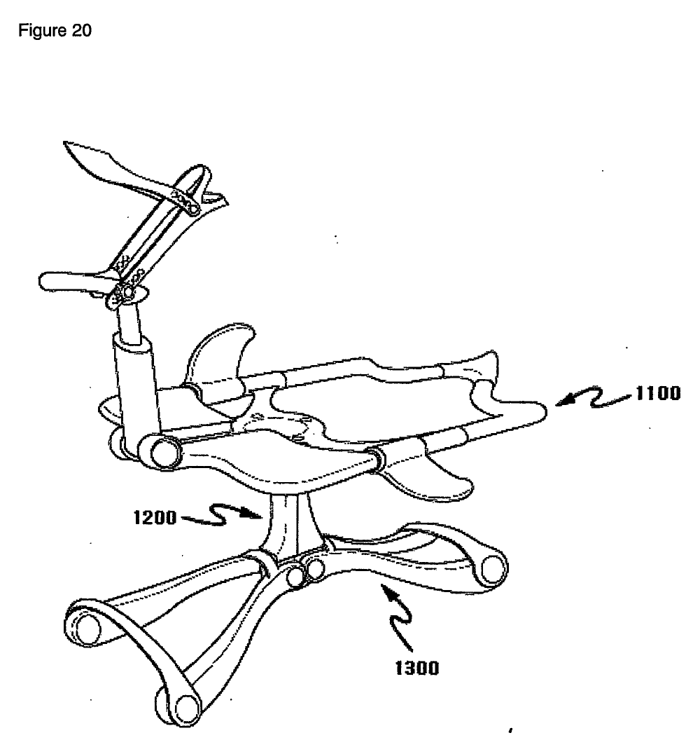

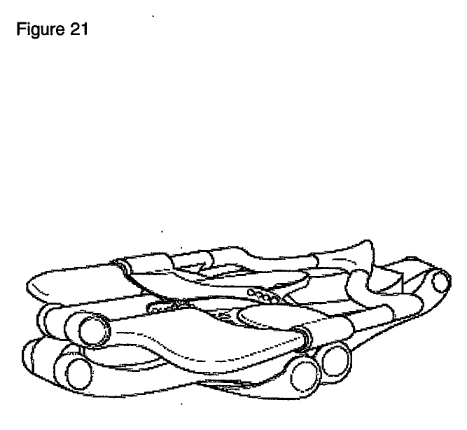

FIGS. 20 and 21 are perspective views illustrating the unfolded and folded states of a system having beauty, medical and bath functions for pets according to another embodiment of the present invention.

As shown in FIG. 20, the system having beauty, medical and bath functions for pets according to the present invention includes a bathtub stand 1100 for fixing a pet's head and body during bathing, beauty and medical operations, a bathtub stand height adjusting unit 1200 for supporting the bathtub stand 1100 and adjusting the height of the bathtub stand 1100, and a stand leg part 1300 that operates as a support for supporting the bathtub stand height adjusting unit 1200 and that includes a suspension bar connected between the both ends of the leg. Since the detailed construction of the bathtub stand 1100 has been described in the above with reference to FIG. 5, the description of the same will be omitted.

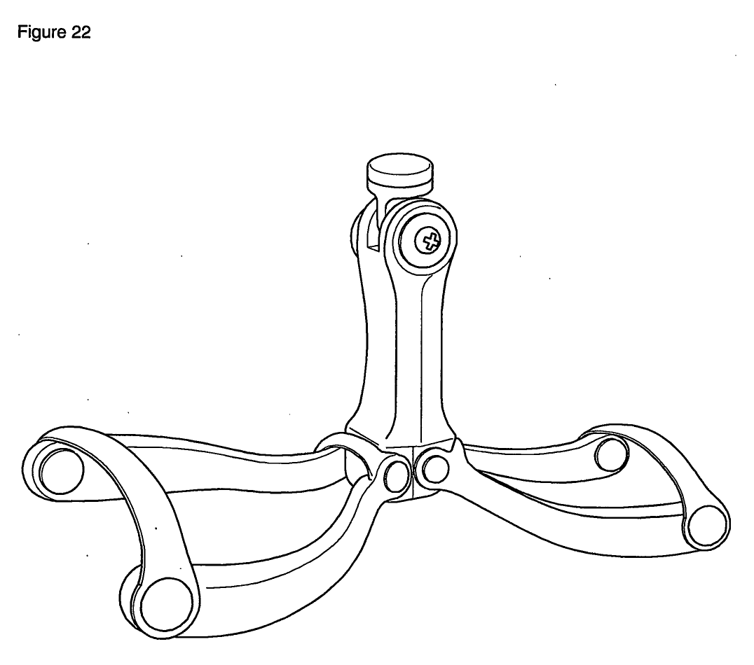

FIG. 22 is a perspective view illustrating a stand leg part of a system having beauty, medical and bath functions for pets according to the present invention.

As shown in FIG. 22, the stand leg part 1200 may maintain a horizontal state based on a suspension bar connected between the both ends. As a result, it is possible to provide a certain comfort when the pet is seated. In addition, the stand leg part 1300 is foldable, so that it is stored after use by folding the same.

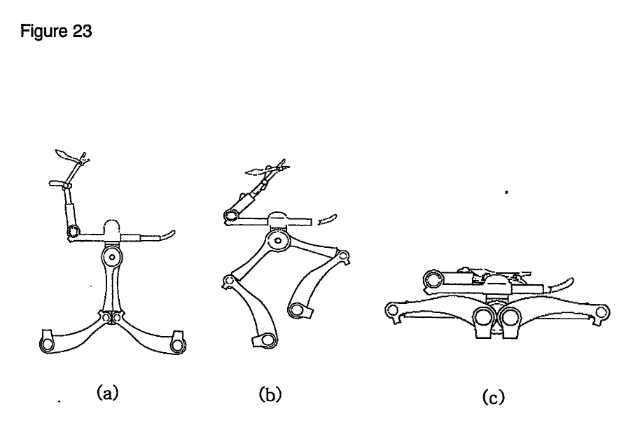

FIG. 23 is a view of an operation state of a method of folding the stand leg part of FIG. 22. As shown in FIGS. 23A, 23B, and 23C, the stand leg part 1300 is formed in a joint type at the leg joints, and the connection points of the joints.

Therefore, as shown in FIG. 21, the bathtub stand 1100, the bathtub stand height adjusting unit 1200, and the stand leg part 1300 are folded and stored for thereby minimizing the total volume of the same after the use of the bathtub is finished.

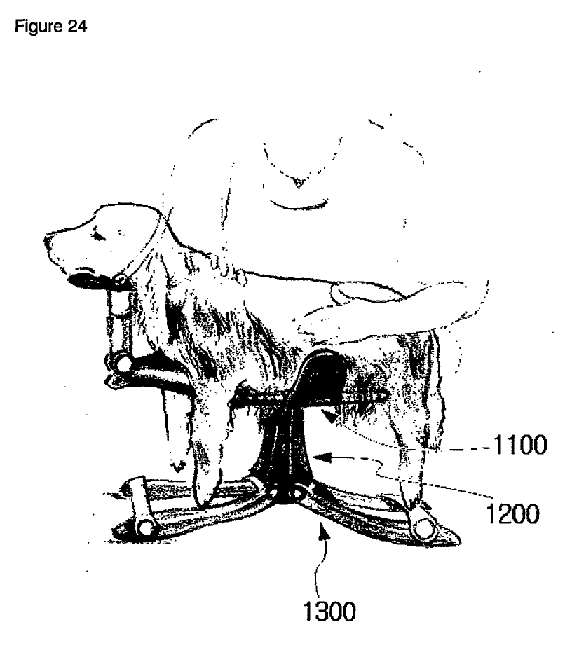

FIG. 24 is a view of a use state of a system having beauty, medical and bath functions for pets according to an embodiment of the present invention. As shown therein, it is possible to stably and conveniently perform bathing, beauty, and medical operations at any places using a system having beauty, medical and bath functions for pets according to the present invention.

### INDUSTRIAL APPLICABILITY

Accordingly, it is obvious that any one who skilled in the art may change or modify the constructions of the bathtub stand, etc. without departing from the concept and ranges of the present invention.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A system having beauty, medical and bath functions for pets, comprising:
a bathtub stand for fixing a pet's head and body;
a bathtub stand adjusting member for supporting the bathtub; ; and
a bathtub for storing water therein,
wherein said bathtub stand adjusting member is installed at a bottom of the bathtub and said bathtub stand includes a head rest for fixing a pet's head; a neck fixing member for adjusting the length and angle based on a pet's neck size; and a body supporting member for supporting the body of the pet.

2. The system of claim 1, wherein said bathtub stand further includes:
a fixing band for fixing a pet's head.

3. (canceled)

4. The system of claim 1, wherein said body supporting member is designed to adjust the length based on the size of the pet.

5. The system of claim 1, wherein said bathtub stand further includes a body side safety support fixing member for stably supporting the left and right sides of the pet's body during beauty, medical and bath operations wherein the angle of the same are adjustable based on the size of the pet's body.

6. The system of claim 2, wherein said bathtub stand further includes a protection cap hinged at the head fixing band wherein said protection cap is movable upwardly and downwardly.

7. The system of claim 1, further comprising a bathtub stand rotation member for rotating the bathtub at 360° with a four-step rotation adjusting level.

8-17. (canceled)

18. The system of claim 1, wherein a drier arm is free-rotatably hinged at one side surface of an inner upper end of the bathtub and a shower unit arm is free-rotatably hinged at the other side surface of an inner upper end of the bathtub.

19. (canceled)

20. The system of claim 18, wherein said drier arm and said shower unit arm are combined.

21. The system of claim 18, wherein said drier arm and said shower unit arm are stored at one side surface of an inner upper end of the bathtub.

22-26. (canceled)

27. A system having beauty, medical and bath functions for pets, comprising:
a bathtub stand for fixing a pet's head and body:
a bathtub stand adjusting member for supporting the bathtub; and
a stand leg unit that operates as a support for supporting the bathtub stand adjusting member, wherein said stand leg unit is foldable legs in which the joints of the legs and the connection points of the joints are foldable in a joint type and is freely folded or unfolded.

28. The system of claim 27, wherein said bathtub stand includes:
a head rest for fixing a pet's head;
a neck fixing member for adjusting the length and angle based on a pet's neck size; and
a body supporting member for supporting the body of the pet.

29. (canceled)

30. The system of claim 28, wherein said body supporting member is designed to adjust the length based on the size of the pet

31. The system of claim 27, wherein said bathtub stand further includes a body side safety support fixing member for stably supporting the left and right sides of the pet's body during beauty, medical and bath operations wherein the angle of the same are adjustable based on the size of the pet's body.

32. (canceled)

33. The system of claim 27, further comprising a bathtub stand rotation member for rotating the bathtub at 360° with a four-step rotation adjusting level.

34-36. (canceled)

37. The system of claim 1, wherein said bathtub stand adjusting member adjusts the height of the bathtub stand.
